(19) United States
(12) Patent Application Publication
(10) Pub. No.: US 2013/0237290 A1
(43) Pub. Date: Sep. 12, 2013

(54) Protective Communications Device Housing for Retractable Audio Devices Having Optional Gripping Mechanism

(71) Applicants: Arthur Roland Simmons, JR., Chesapeake, VA (US); Arthur Roland Simmons, SR., Chesapeake, VA (US)

(72) Inventors: Arthur Roland Simmons, JR., Chesapeake, VA (US); Arthur Roland Simmons, SR., Chesapeake, VA (US)

(21) Appl. No.: 13/278,466

(22) Filed: Oct. 21, 2011

Related U.S. Application Data
(60) Provisional application No. 61/405,602, filed on Oct. 21, 2010.

(51) Int. Cl. H04M 1/60

(52) U.S. Cl. CPC H04M 1/6058
USPC 455/569.1

(57) ABSTRACT

A retractable audio device housing system includes a housing having internal dimensions substantially the same as external dimensions of a mobile communications device that includes an internal cavity for mounting a retracting cord mechanism. The internal cavity has at least one wall that separates a first end of a cord capable of transmitting an electrical signal from a second end of the cord, the first end of the cord has a connector plug adapted to be connected to an output port of the mobile communications device and the second end of the cord has at least one earpiece, wherein when the second end of cord is extracted, the retracting mechanism becomes tensioned. The housing further includes an internal chamber for securing the retracting mechanism and for positioning the first end of the cord and the second end of the cord on opposite sides of the wall.

### COPENDING APPLICATION

This application claims priority benefit of Provisional Patent Application No. 61/405,602, filed Oct. 21, 2010, titled “RETRACTABLE LISTENING DEVICE (HEADPHONES) IN A PROTECTIVE CASING WHICH ALSO PROTECTS CELL PHONE” having the Arthur Roland Simmons, Jr. named as the inventor and which is incorporated herein by references as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

1. Field

The invention relates to housings or skins for communications deices, and in particular, to a protective skin for a communications media device that stores retractable audio or headset devices (e.g., earphones, remote microphone, etc.) for use with the communications media device.

2. Background

Currently, most mobile communications devices (e.g., cell phones, Black Berry devices, iPhones, Driods, etc.) have media player functionality and some have the ability to run applications (e.g., “smart” phones). These mobile communications devices are indispensable in our daily lives and are used worldwide in immeasurable numbers due to their practicality, increasing cost effectiveness, convenience and ease of use, and entertainment abilities. However, the use of mobile communications devices is not without inherent risks. For example, many individuals make and receive calls while driving. This action necessarily requires the use of at least one hand to operate and/or hold the mobile communications device, substantially increasing the risk of an automobile accident causing possible injury to oneself and others. In addition, overexposure to potential radiation has become a recognized phenomenon warranting consumer concern.

Thus, a need has arisen for a means by which a mobile communications device can be utilized in a “hands-free” manner. Hands-free is understood to mean the ability to transmit and receive audio signals through a mobile communications device without the user having to tediously hold the mobile communications device proximate to the user's ear and mouth. One development for mobile communications devices to address this issue is an integrated speakerphone function. The speakerphone function of mobile communications devices has become widely used, especially during walking, working or driving a car. The speakerphone function provides the safety of the user in using the phone, especially during driving. However, even with the speakerphone functions, there are limitations.

One of the limitations with the speakerphone function is poor audio performance. In a conventional speakerphone implementation, the main components include a cradle, a loudspeaker to broadcast audio signals from the phone and a microphone to receive audio signals (i.e., signal containing the user's voice). The poor audio performance results from the distance between the user's mouth and the microphone that allows ambient sounds to blend with the user's voice and causes noise. Even with current noise cancellation technology, the ambient noise interference creates poor audio performance. Additionally, the use of the loudspeaker increases ambient noise due to additional feedback, particularly in automobiles, use around heavy equipment, and use in crowded or noisy environments (e.g., sporting events, concerts, etc.) where mobile communications devices are commonly used. Further, for privacy concerns, a user not desire to utilize the speakerphone function.

To overcome problems associated with speakerphone systems, headsets (e.g., earphones integrated with a remote microphone) have been used in conjunction with mobile communications devices to provide better quality audio reception and transmission. These headsets be used in conjunction with cradles that hold the communications device in place in an automobile or on a user. The headsets are typically connected to the communications device or the cradle with a cord that transmits and receives the audio signals between the communications device and the user's ear and mouth. Unfortunately, the headset and cord combination create a unique set of problems that bring further limitations.

One such problem is the placement of the headset and communications device when not in use. If the communications device is not in a cradle while it is an automobile, the headset and communications device move around the interior and create a dangerous situation for one attempting to answer an incoming call or otherwise use the communications device and headset while driving or engaging in another activity. The communications device and headset may not remain together, and therefore locating the communications device and headset may create a distraction. Another problem is that the cord becomes a distraction to a user since the cord become tangled or looped around other objects, about the user, or about barriers. If this happens, problems will occur and interfere with use of the communications device. Yet another problem is the inconvenience caused by the length of the cable of the headset. Often, because the length of the cable must be long enough to reach from the waist of the user to their ear, the cable must be at least two or three feet in length. When not in use, this length of cable becomes a nuisance, often catching on protrusions and tearing the mobile communications device out of the user's pocket or the earpiece out of the user's ear. Thus, with current headsets, considerable wrapping and tangling occurs with the cables. Many times an individual will lose or break the earpiece because there is no proper storage while it is not in use.

### SUMMARY

The aforementioned problems, and other problems, are reduced, according to exemplary embodiments, by the protective communications device housing for retractable audio devices having an optional gripping mechanism (also referred to herein as the “retractable audio device housing system”) that is configured to provide a an easy to use headset retraction system stored in protective housing that affixes to a mobile communications device, such as a “smart” phone, satellite phone, cell phone, etc.

The present invention provides a retractable audio device housing system and device useful for a variety type of audio devices, including mobile phones, audio players and cordless telephones, as well as video devices that have an audio output.

In an exemplary embodiment, the retractable audio device housing system includes a housing having internal dimensions substantially the same as the external dimensions of a mobile communications device, the housing comprises an internal cavity for mourning a retracting mechanism, wherein the cavity includes at least one wall extending along an interior surface of the housing. The exterior of the housing is substantially flat and include an aperture that fits about a camera or other space that needs immediate access of the mobile communications device. The earpieces rest along an exterior surface of the housing in substantial alignment of an end or edge of the mobile communications device. Interior side walls of the housing include ribbing or other gripping mechanism for attachment to the mobile communications device. Still further exemplary embodiments provide an internal chamber of the housing, the internal chamber for securing the retracting mechanism and for positioning a first end of the cord and a second end of the cord on opposite sides of the wall. The first end of the cord includes a connector plug adapted to be electrically connected to an output port of the mobile communications device and the second end of the cord includes at least one earpiece, wherein when the second end of cord is extracted from the cavity, the retracting mechanism becomes tensioned.

In some of the exemplary embodiments, the retracting mechanism includes a drive wheel rotatably disposed within a reel, an idler wheel rotatably disposed within the reel and positioned adjacent and opposed to the drive wheel; and a spring coupled to one of the drive wheel and idler wheel to bias the rotational movement of the one of the drive wheel and idler wheel; wherein the cord is interposed between and contacts both the drive wheel and the idler wheel, and the cord is retractably extracted from the housing by pulling a portion of the second end away from the housing, and therein causing the spring to be tensioned.

In further exemplary embodiments, the retractable audio device housing system is configured to be used to internally store foldable earpieces about a surface of the mobile communications device. The foldable earpieces have an external surface that is near flush with an external surface of the housing and thereby reduce entanglement and breaking of the earpieces. Some additional advantages of the foldable earpieces include reducing dirt and grime from collecting on the earpieces and a more aesthetic look of the housing such that it mimics conventional “skins” used with mobile communications devices.

Still further exemplary embodiments provide for an optional microphone positioned proximate to the second end of the cord and attachment or holding devices for positioning the retractable audio device housing system on a user. The attachment and holding devices may include a clip mounted or integrated on an external portion of the housing, a strap mounting mechanism that enables a user to strap the retractable audio device housing system about a wrist or arm, and a handle or grip piece for the user's hand to hold the retractable audio device housing system.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### DESCRIPTION OF THE DRAWINGS

The exemplary embodiments, objects, uses, advantages, and novel features are more clearly understood by reference to the following description taken in connection with the accompanying figures wherein:

FIG. 1 is a perspective front view of a retractable audio device housing system configured in accordance to some of the exemplary embodiments of the present invention;

FIG. 2 is a perspective back view of the retractable audio device housing system of FIG. 1.

FIG. 3 is an exploded perspective front view of the interior housing and reel system of the retractable audio device housing system of FIG. 1.

FIGS. 4 and 5 are perspective front views of the interior housing with the mated reel system of the retractable audio device housing system of FIG. 1. p FIG. 6 is a perspective top view of the retractable audio device housing system of FIG. 1.

FIG. 7 is an exploded perspective view showing components of the reel system of the retractable audio device housing system of FIG. 1.

FIGS. 8, 9A, 9B, 9C and 9D are perspective views of an alternate jack and foldable earpieces in accordance with some of the exemplary embodiments of the present invention.

FIG. 10 illustrates perspective views of an alternate housing for use with the components shown in FIGS. 8, 9A, 9B, 9C and 9D.

FIG. 11 illustrates the retractable audio device housing system of FIG. 1 having an exemplary microphone built into the second end of the cord.

FIGS. 12 and 13 illustrate the retractable audio device housing system of FIG. 1 having a clipping device.

FIG. 14 illustrates another retractable audio device housing system that is configured with a user strap mounting mechanism in accordance with some of the exemplary embodiments of the present invention.

FIG. 15 shows a perspective view of the retractable audio device housing system configured with the user mounting strap being worn by a user in accordance with some of the exemplary embodiments of the present invention.

FIG. 16 illustrates another retractable audio device housing system with an alternate configuration for use with an alternate user strap mounting mechanism in accordance with some of the exemplary embodiments of the present invention.

FIG. 17 illustrates a perspective view of a retractable audio device housing system configured for use with a communications tablet device in accordance with some of the exemplary embodiments of the present invention.

FIG. 18 illustrates another retractable audio device housing system of FIG. 17 having an integrated, movable gripping or handle mechanism in accordance with some of the exemplary embodiments of the present invention.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill the art understands. An example is that the materials used for the exemplary embodiments may be made out of man-made materials (e.g., plastics, metals, etc.), natural materials, and combinations thereof. A further example is that the apparatus or components of the apparatus may be manufactured by machine(s), human(s) and combinations thereof.

The functions of the various elements shown in the figures may be provided through the use of dedicated hardware as well as hardware capable of executing software in association with appropriate software. Other hardware, conventional and/or custom, may also be included. Those skilled in the art further understand that the exemplary hardware, software, processes, methods, and/or operating systems described herein are for illustrative purposes and, thus, are not intended to be limited to any particular named manufacturer.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention is a retractable audio device housing system and device that is adapted for use for mobile communications devices, such as “smart phones”, cellular phones, and cordless communications devices. Further, the retractable audio device housing system may also be used with other mobile audio media devices such as portable audio electronic devices, including iPods, MP3 players, AM/FM devices and the like. Still further, the system may also be used with video playback or other multimedia devices, e.g., electronic book readers, DVD players, digital video players, iPads, personal computers, and other devices that have audio output. For purposes of the following description, the use of the retractable audio device housing system will be assumed for smart phones.

In some of the embodiments, the present invention allows users to attach or affix the retractable audio device housing system in a semi-permanent fashion to a smart phone for a user-friendlier earpiece device for hands-free communications. The retractable audio device housing system attempts to eliminate current problems that exist with speaker/earpiece devices which do not retract and are not semi-permanently/permanently affixed to the phone; tangling, losing, kinking, misplacing or breaking of the cable or speaker/earpiece itself.

In further exemplary embodiments, the retractable audio device housing system is configured to internally store foldable earpieces about a surface of the mobile communications device. The foldable earpieces have an external surface that is near flush with an external surface of the housing and thereby reduce entanglement and breaking of the earpieces. Some additional advantages of the foldable earpieces include reducing dirt and grime from collecting on the earpieces and a more aesthetic look of the housing such that it mimics conventional “skins” used with mobile communications devices.

Still other exemplary embodiments provide for an optional microphone as well as attachment or holding mechanisms for positioning the retractable audio device housing system on a user. The attachment and holding mechanism may include a clip mounted or integrated on an external portion of the housing, a strap mounting mechanism that enables a user to strap the retractable audio device housing system about a wrist or arm, and a handle or grip piece for the user's hand to hold the retractable audio device housing system.

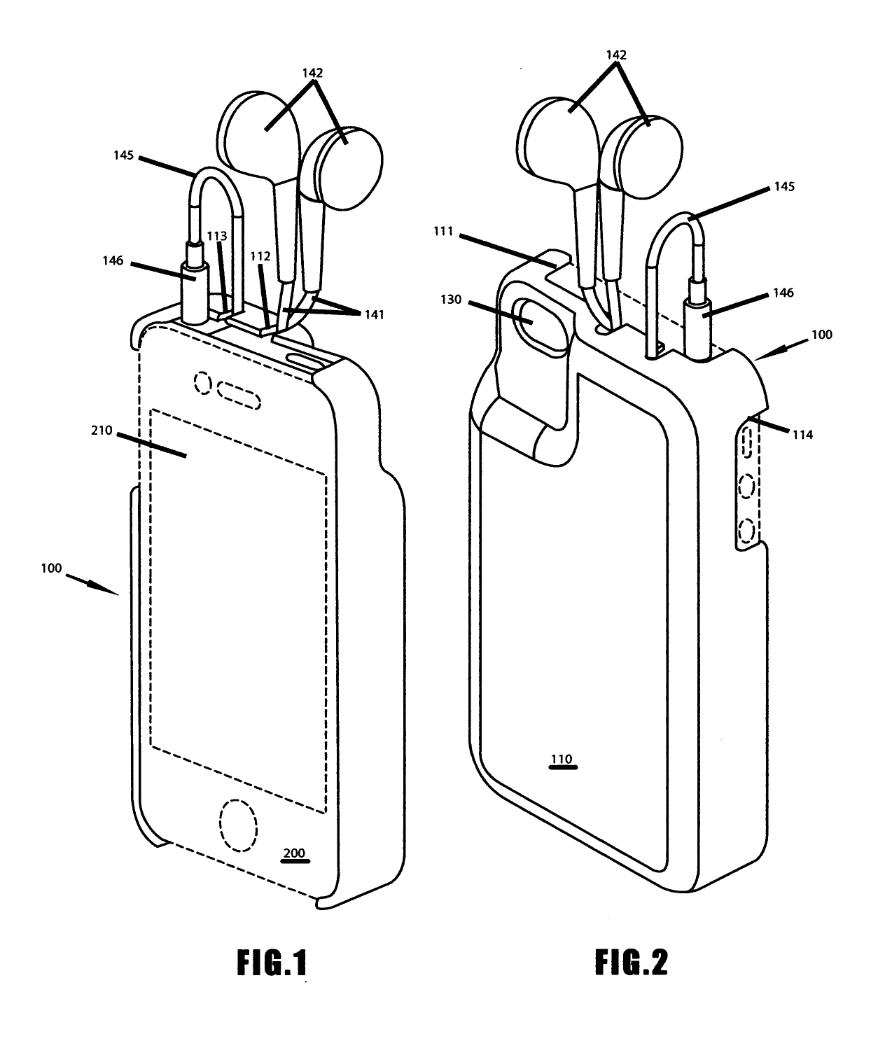

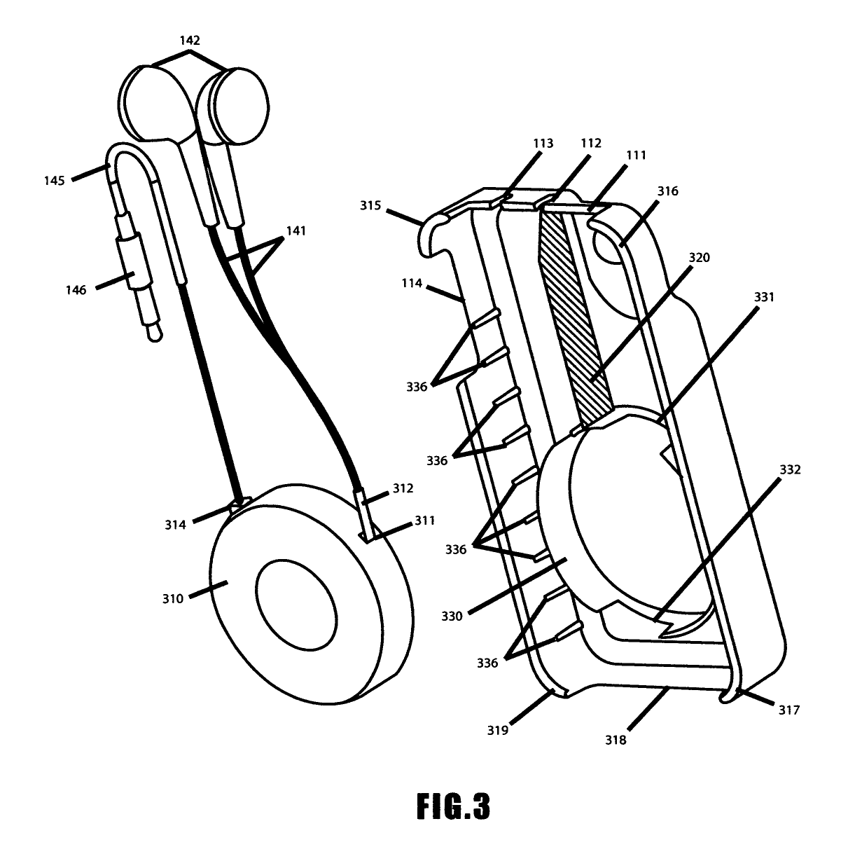

Referring now to the figures, FIG. 1 and FIG. 2 illustrate a retractable audio device housing system 100 configured in accordance with some of the embodiments. Retractable audio device housing system 100 includes a housing 110 that may be mounted to a mobile communications device 200 (shown in dashed lines). The retractable audio device housing system 110 includes several apertures that are complimentary configured to allow for access to components of the mobile communications device 200. For example, the housing fits about the edges of the mobile communications device 200 such that a display 210 remains unobstructed and viewable to a user. Similarly, aperture 130 is configured to allow access to a camera or image gathering input (not shown) of the mobile communications device 200. Aperture 111 is recessed along a top surface of the device that includes additional aperture 112 for positioning cords 141 of earpieces 142 and aperture 113 for positioning cord 145 of plug 146 that is shown engaged with a port of the communications device. Furthermore, aperture 114 along a side edge of the housing 110 allows access to additional ports of the communications device 200.

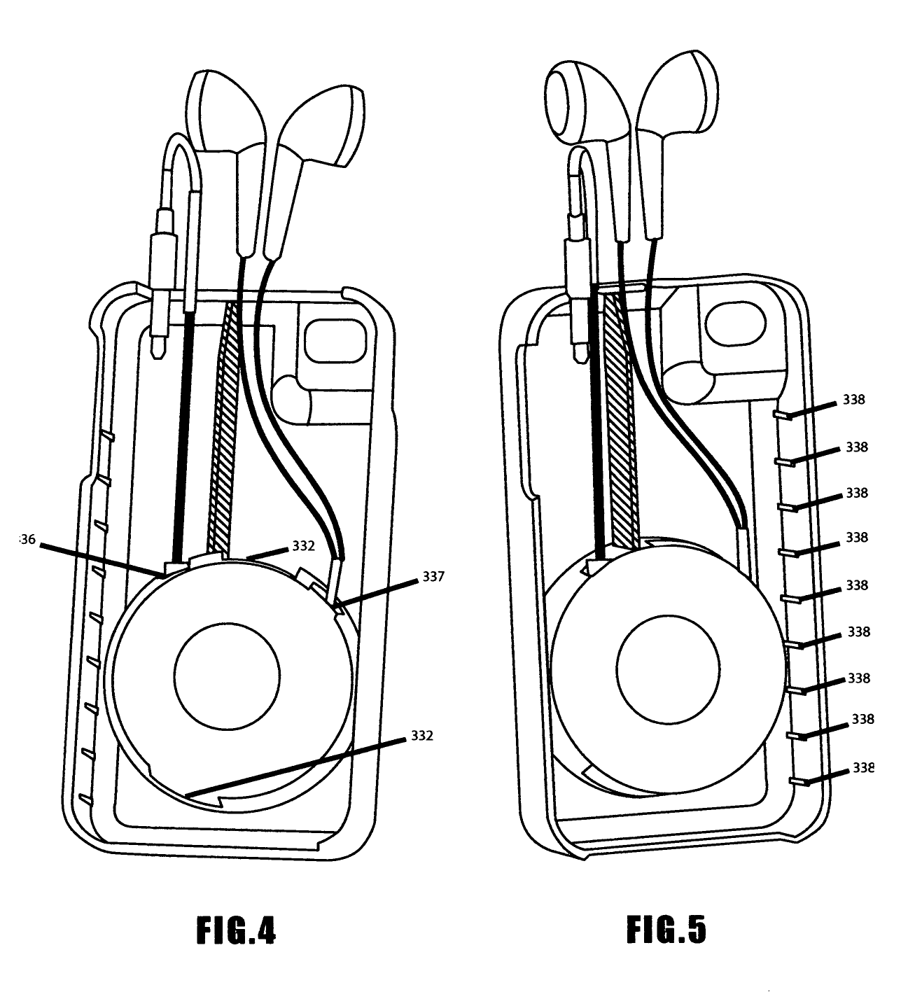

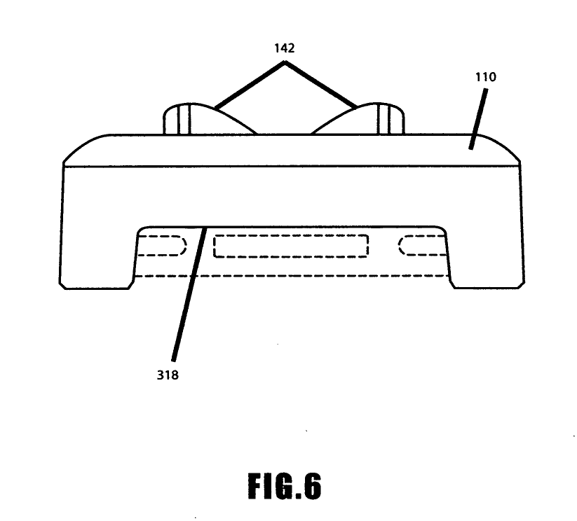

Referring now to FIGS. 3, 4 and 5, the interior components and feature of the retractable audio device housing will now be described. FIG. 3 shows an exploded view of the interior components of the retractable audio device housing system 110 including a retracting mechanism 310 and the housing 110. FIGS. 4 and 5 show perspective views of the arrangement of interior components of the retractable audio device housing system 110. In FIG. 3, the end of the cord 145 having the connector 146 is stationary and further includes a stationary mechanism including stop 314 that prevents the end of the cord 145 from extending or retracting. That is, the end of the cord 145 having the connector is relatively stationary or free of any movement in order to maintain a predetermined length of cord for connecting the connector 146 to an outlet port of the communications device 200. The other end of the cord 141 having the earpieces 141 extends and retracts in response to the user exerting a light pulling force on the end of the cord. Such retracting mechanisms typically include a spring and reel mechanism; however, this invention may alternate extension and retracting mechanisms that move the end of the cord 141 with earpieces 142.

As illustrated in FIG. 3, the end of the cord 141 with earpieces 142 includes two separated cords each end having its own earpiece (i.e., there are two earpieces—one for each ear of the user). In order to minimize entanglement, the cord 141 further includes a casing 311 that encases the two separated cords such that one combined cord within casing 311 is contained and reeled within the retracting mechanism. Another advantage of using casing 311 is to protect and minimize wear on the portion of the cord that is being extended and retracted. Alternatively, the end of the cord 141 may be one cord with one earpiece 142 (not shown) which may not include casing 311.

The housing 110 is shown with many apertures and internal features that provide advantages for the retracting mechanism 310. Internal chamber 330 is designed to hold retracting mechanism 310 in a friction fit or alternate mounting (e.g., snap fit (not shown)). To remove the retracting mechanism 310, the user extends his or her fingers through the apertures 331 and 332 and exerts slight opposing forces onto the retracting mechanism 310 which becomes slightly distorted to easily be removed from the internal chamber 330.

A wall 320 extending along the interior of the housing 110 is shown nearly perpendicular to a wall of the internal chamber 330 and serves to separate each end of the headset cord into two separate compartments of the housing 110. By keeping the second end of the cord 141 in its own compartment, any slack in the cord 141 is prevented from entering the compartment with the other end of the cord 145 to minimize entanglement and maintain an arrangement that best utilizes the one-way retracting mechanism 310. The end of the cord 145 with the connector exits the internal chamber at aperture 336 (shown in FIG. 4) into one compartment of the housing 110. The end of the cord 141 exits the internal chamber at aperture 337 (shown in FIG. 4) into the other compartment separated by wall 320. As appreciated by one of ordinary skill in the art, the retracting mechanism 310 can utilize any design that enables an end of an electrical cord 141 having earpieces 142 to extend and retract from the housing 110 while keeping the end of the electrical cord 145 having the connector plug 146 stationary.

Additional features of the interior components include ribbing 336, 338 on opposite side walls of the housing 110 that enable a friction or snap fit with the mobile communications device (shown as reference numeral 200 in FIGS. 1 and 2). The ribbing 336, 338 be configured to best fit of the exterior of the mobile communications device 200 such that the housing 110 stays attached. As illustrated in FIG. 3, a top surface of the housing 110 includes a large aperture 111 that includes two additional apertures 113, 112. Thereafter, a side surface 316 starts at the corner of the top surface and extends to a corner of the bottom surface 317. As best illustrated in FIG. 6, the bottom surface includes another aperture 318 that extends to expose input and output ports of the mobile communications device (not shown). Thereafter, as best illustrated in FIG. 3, another side surface 319 starts at the corner of the bottom surface and extends to a corner of the top surface 315. That side includes an additional aperture 114 that is configured to expose additional input or output ports of the mobile communications device (not shown). The housing may be made of a variety of materials, preferably plastic or polymer structure. However, other man-made and natural materials may be used. Furthermore, the headset is similar to many conventional headsets and may include additional cord length to account for a portion that remains in the housing 110. According to one of the embodiments, length of the headset cord is between three (3) and four (4) feet. However, other lengths may be utilized depending on the required deployment of retractable audio device housing system 100. Thus, in some of the exemplary embodiments, the characteristics of any retraction spring must be selected to allow for the amount of extraction of cord to occur without over-tensioning spring.

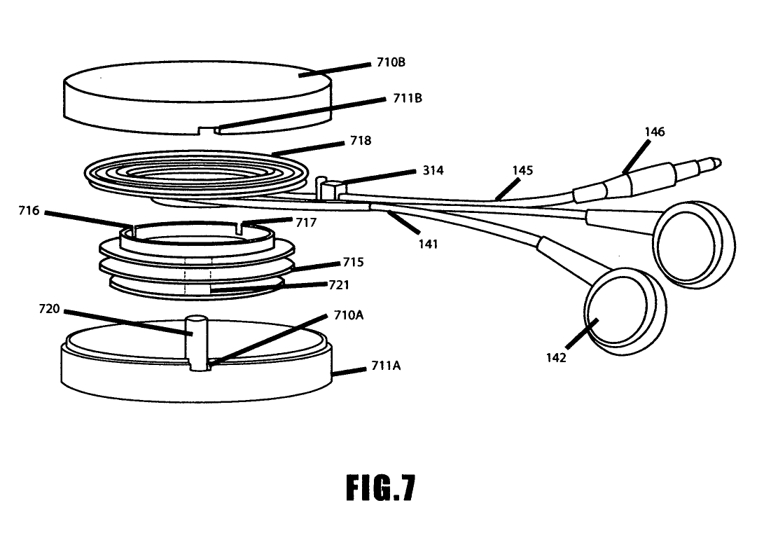

Referring now to the exemplary embodiments of FIG. 7, an exploded vies of the retracting mechanism housing 320 illustrate some of the interior components and arrangement. The retracting mechanism includes two pieces 711A, 711B that snap fit together. Within the two pieces 711A, 711B, a drive wheel 715 holds coiled cord 718 about the guided external ridges 715 that keep the cord 718 from overlapping as it is retracted and extended. The ridges 715 extend nearly to the internal walls of the two pieces 711A, 711B. Aperture 711 is formed by the mating of the two pieces 710A and 710B and allows the end of cord 141 with earpieces 142 to exit the retracting mechanism. The drive wheel 715 acts as a reel used with a spring (not shown) for reeling in slack cord during the use and for retracting the cord when the earpieces are desired to fully seat in aperture 112 when the earpieces are not in use. The spring and wheel mechanism can be of any conventional type such that when the spring is released, it causes the drive wheel to rotate and thus wind the cord 141 having the earpieces 142 into the housing formed by the two pieces 711A, 711B. A conventional locking mechanism (not shown) is included in the spring and reel mechanism for selectively locking the cord when the cord is withdrawn from the retracting mechanism housing 320 to a desired length to permit the earpieces 142 to be comfortably placed in the ears of the user. Such locking mechanism can be released in any suitable manner, for example by slightly puffing on the cord such as to cause the cord to be wound about the ridges 715 of the drive wheel 715 by urging the spring and thus retract the cord into the retracting mechanism housing 320.

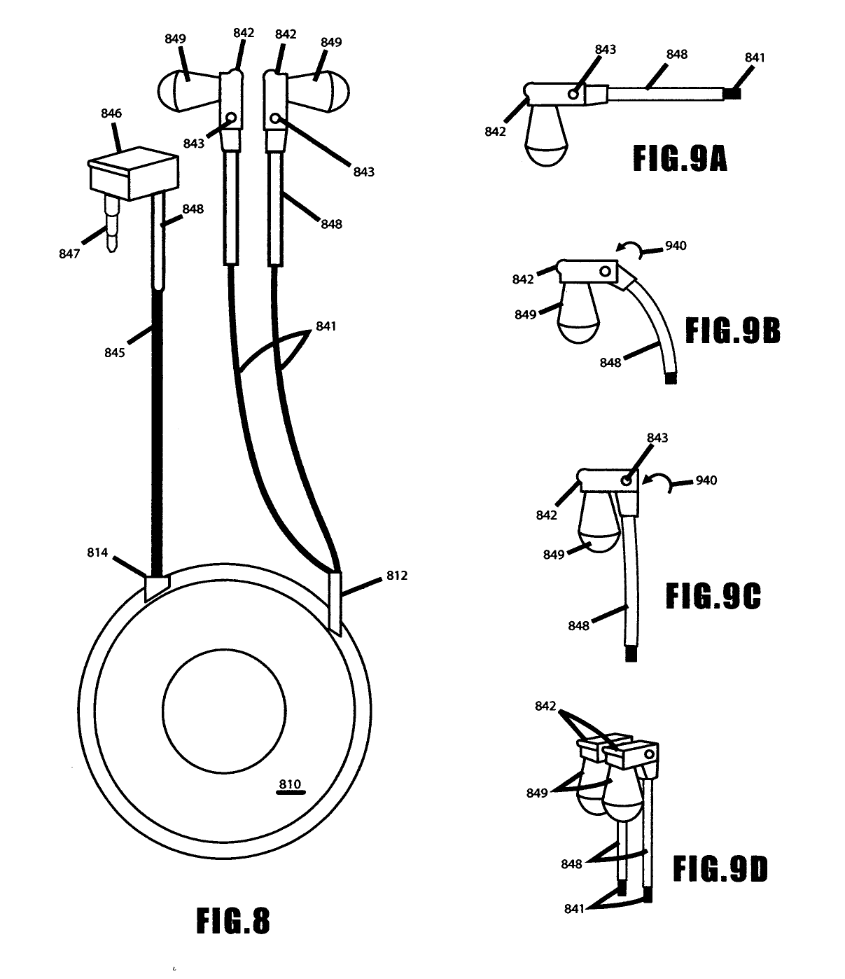

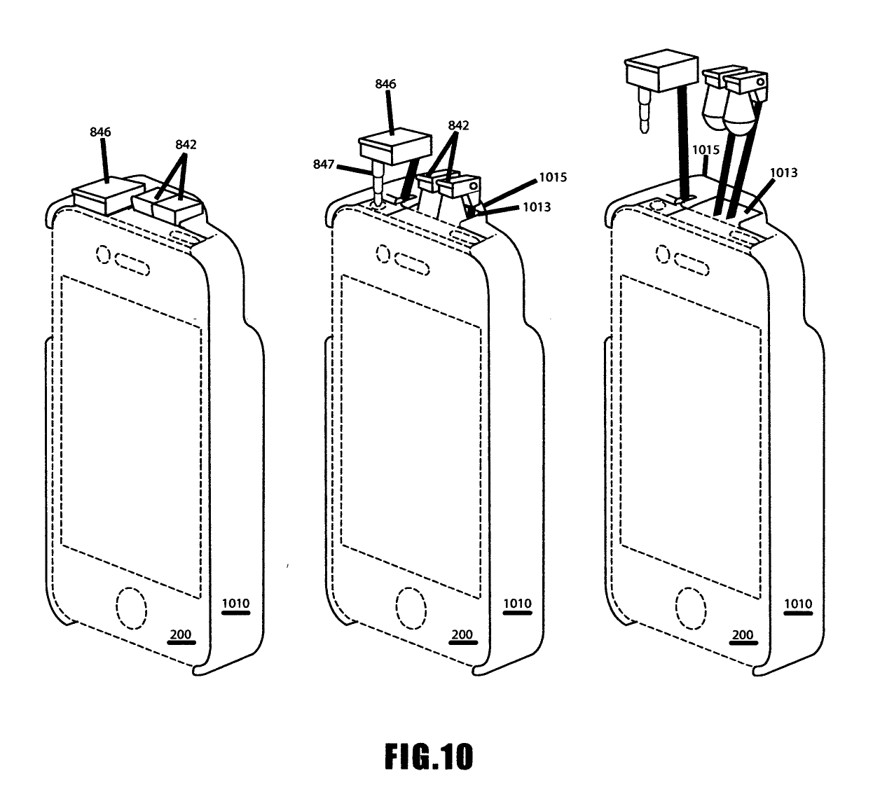

FIGS, 8, 9A, 9B, 9C, 9D, and 10 illustrate uniquely designed foldable earpieces having joint 843 and connector plug housing 846. These unique designs enable the retractable audio device housing system 1010 to house the earpieces in a rearward compartment 1013 protected by contoured cavity 1015. This arrangement enables a nearly flat storage surface along an exterior top side of the housing 1010 as best seen in the left illustration of FIG. 10. Furthermore, the connector plug 847 attaches to the connector plug housing 846 such that when the connector plug 847 is inserted into the port, the top of the connector plug housing 846 is substantially flat and aligns with the top surface of the housing 1010. The cord 845 attached to the connector plug housing 846 includes a protective stem 848 to minimize wear on cord 845. The ear buds 849 are attached to an earpiece housing 842 that include a locking for non-locking) joint 843. When the user wishes to use the ear buds 849, the user pulls the ear buds and locks them into a position illustrated in FIGS. 8 and 9A. When the user wishes to store the earpieces, the user grips stem 848 and pushes the housing 842 towards the stern 848 of cord 841 such that the earpieces move from a position shown in 9A to a position shown in 9B and then into the position shown in 9C. The user does this for each earpiece so that both can be stored as shown in FIG. 9D and in FIG. 10.

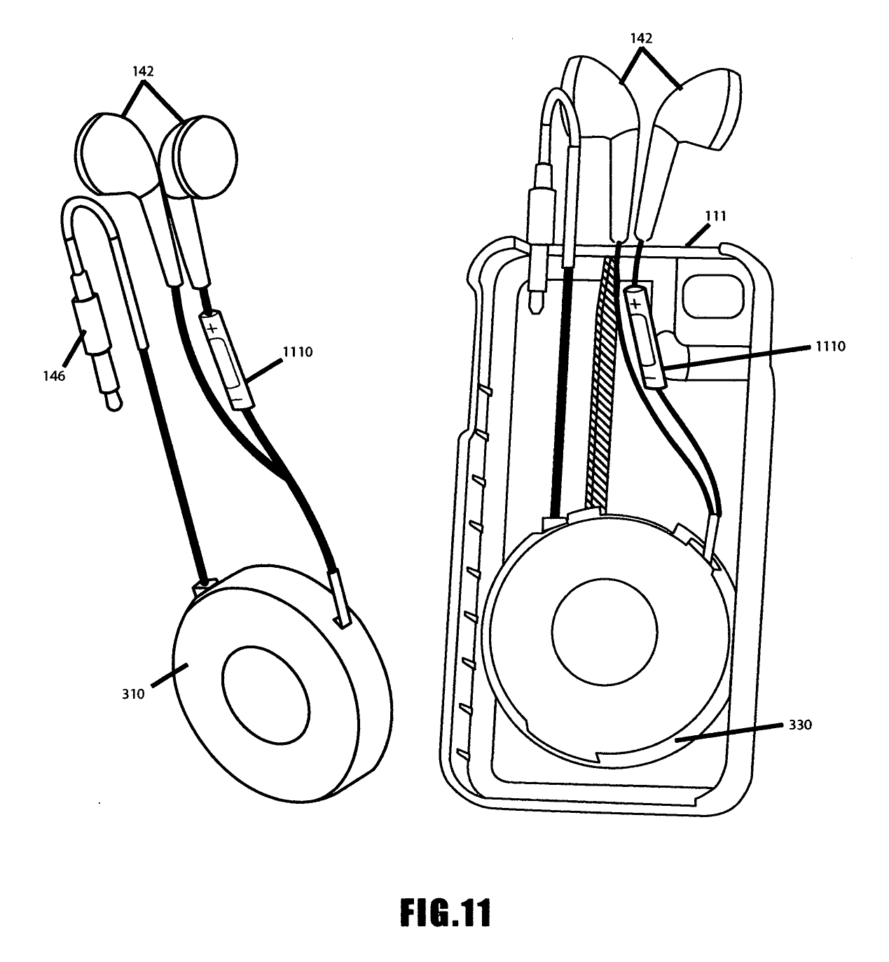

In some of the embodiments, the earpiece (shown as reference numeral 142 in FIGS. 1-7 and reference numeral 849 in FIGS. 8-10) includes both a microphone as well as a speaker such as that typically used for earpieces. Thus, the piece that will go into the ear will contain both the listening (i.e., speaker) and speaking (i.e., microphone) device in one. This will allow the winding or coiling of the cord with the earpiece to be neat and only the small earpieces will be not wound and kept within the housing. In an alternative embodiment shown in FIG. 11, the cord 141 of the earpiece 142 may include a separate microphone 1110 that is located proximate to the earpiece such as to optimize retraction or the cord 141 when the earpiece 142 is not in use and is fully retracted as shown in FIG. 11.

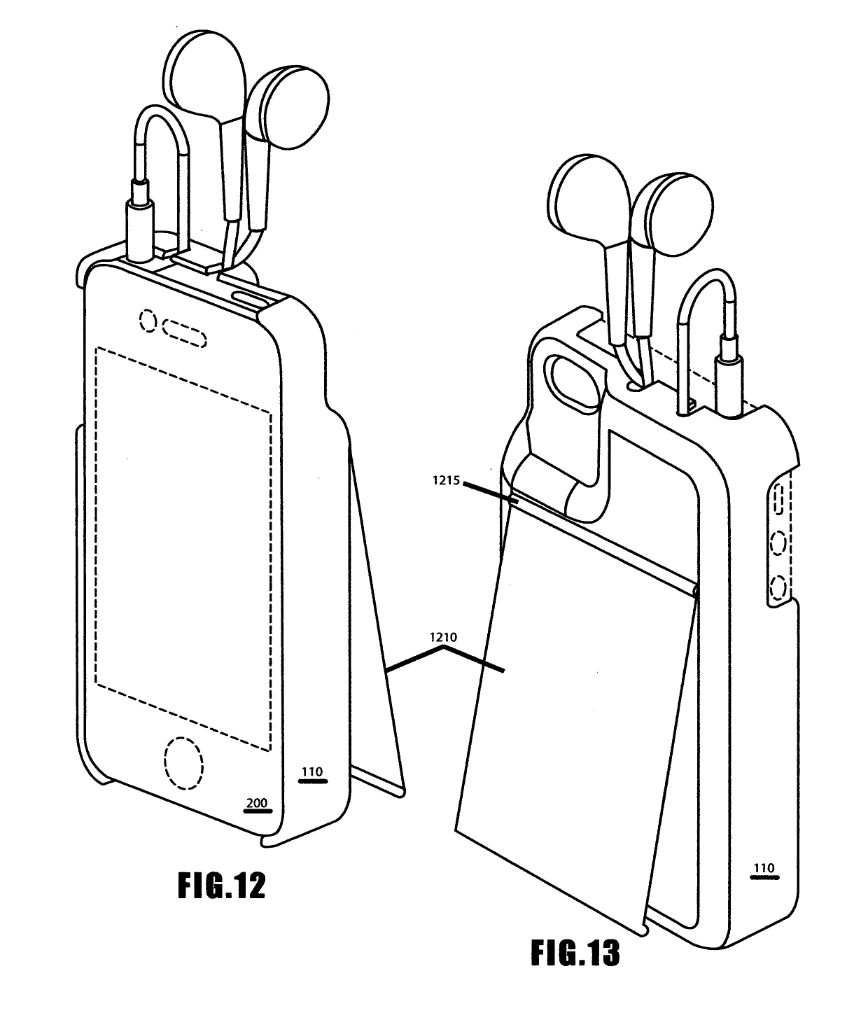

In operation and use, the retractable audio device housing 100 can be positioned close to a user. Alternatively, the retractable audio device housing 100 can be clipped using a clipping device 1210, 1215 shown in FIGS. 12 and 13. That is, the user may prefer to clip the retractable audio device housing 100 to an article of clothing so as to be located near the head and ear of the user. When the user desires to use the earpieces, he or she can pull or otherwise release the cord 141 and position the earpieces 142 so as to receive an incoming call or to listen to audio media. In some of the embodiments, the user can communicate through the mobile communications device 200 by means of the microphone and speaker. Upon termination of the call, the user can withdraw earpiece 142 from the ear, tug slightly on the cord, and retract the cord into the housing 110. The earpiece is then returned to its resting position and locked from storage during nonuse. In this manner the retractable audio device housing 100 permits the user to more easily communicate in a hands free mode without the need of an earpiece clipped onto the user's ear both during and between communications. Because some localities monitor hands-free communications when one is driving, the retractable audio device housing 100 could also include a switch or other logic that interfaces with a processor of the mobile communications device 200 to detect that the user is driving and to monitor use of the retractable audio device housing 100 during an active call. Further embodiments provide that the mobile communications device 200 could send an alert signal (not shown) to the communications provider when the user does not activate the retractable audio device housing 100 and thus implies that the user is not hands-free.

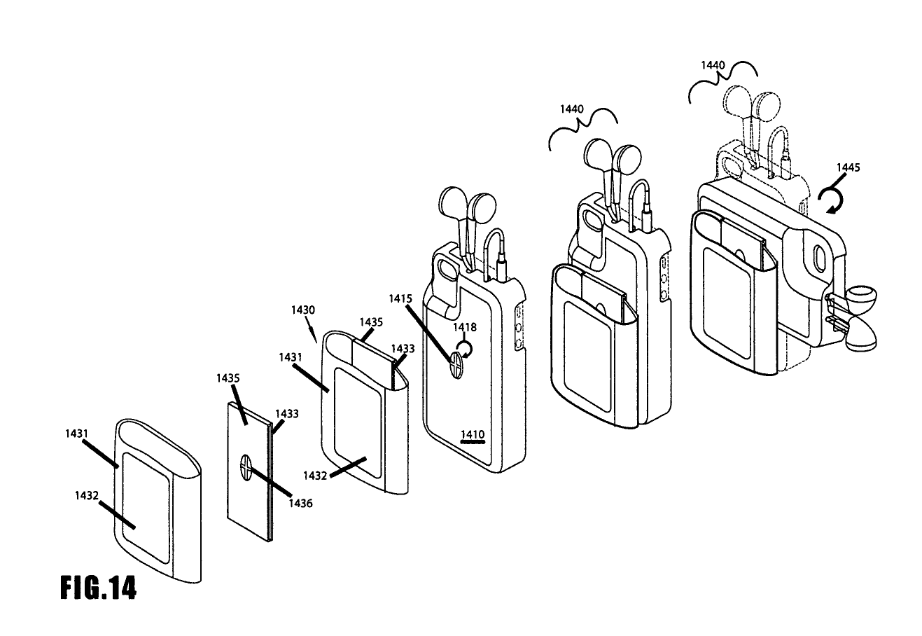

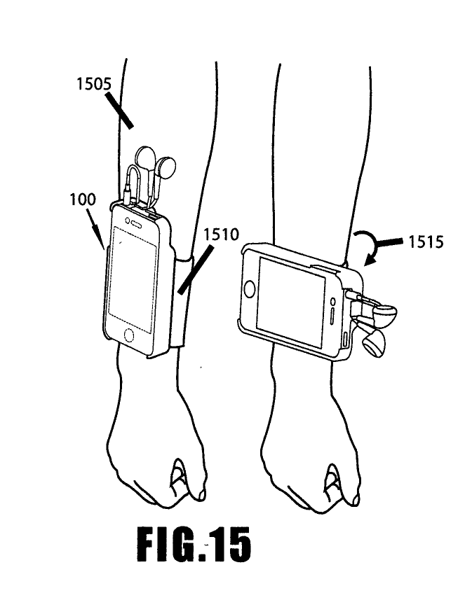

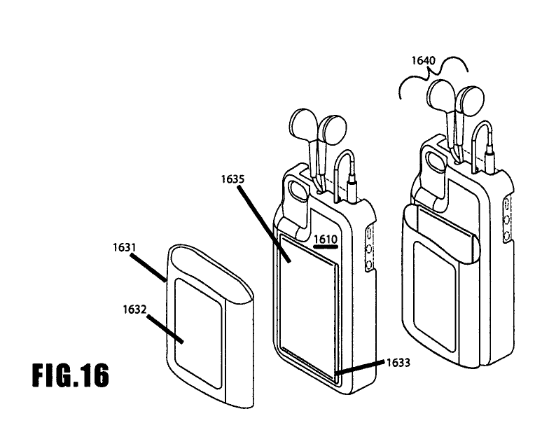

In alternate embodiments, the user may attach the retractable audio device housing system 100 as shown in the illustrations of FIGS. 14, 15, and 16. More specifically, the retractable audio device housing 1410 is configured with a rotatable joint 1418 that mates with a complimentary joint 1436 of a mounting plate 1435. The mounting plat includes a through slot 1433 through which a strap 1431 is positioned. The strap may be secured 1510 to an arm 1505 of a user as shown in FIG. 15 and the retractable audio device housing 1410 can be rotated 360 degrees as shown by arrow 1515. This enables the user to secure the retractable audio device housing system such that the user does not have to worry about dropping the mobile communications device 200. Additional advantages include being able to work hands-free.

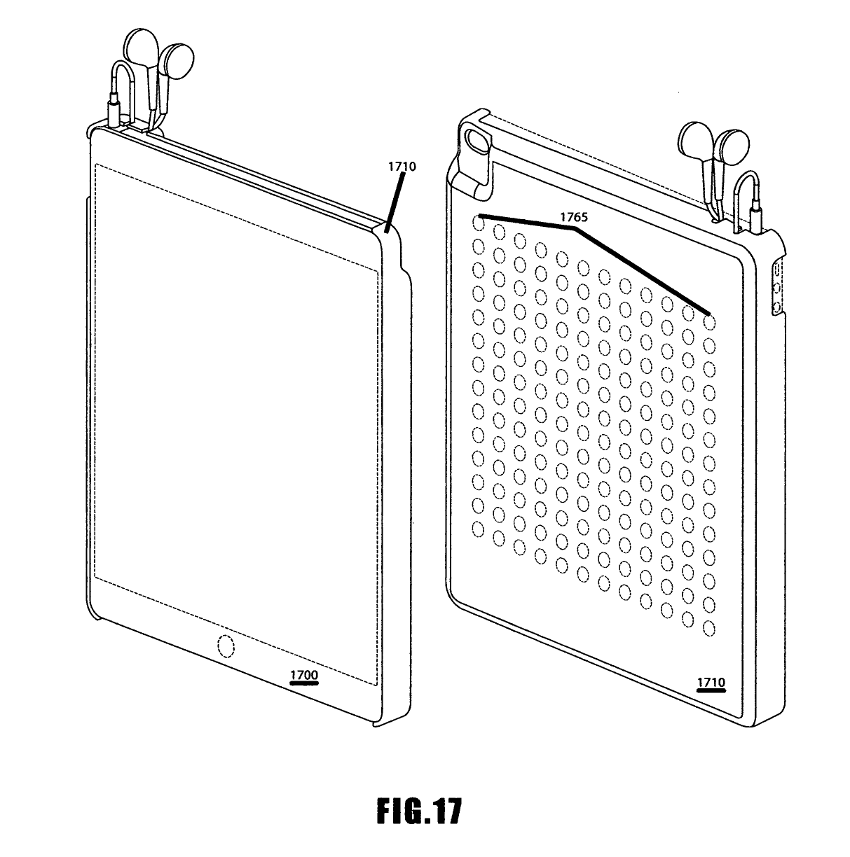

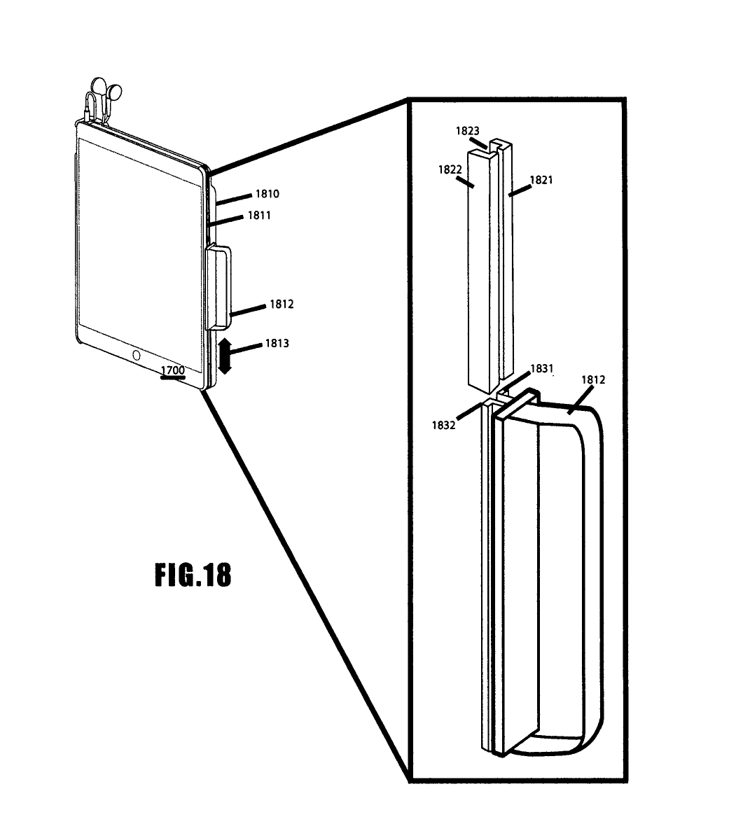

As described above, retractable audio device housing system is applied to a smart phone. However, it should be noted that the system is equally applicable to audio or music players, desktop computers, laptops, or other devices. For example, FIGS. 17 and 18 illustrate use of a retractable audio device housing 1710 configured for a tablet or iPad device 1700. The housing further includes venting apertures 1765 that enable airflow to a backside of the tablet or iPad device 1700.

Referring now to FIG. 18, the retractable audio device housing 1810 further include an al track 1821, 1822, 1823 that is configured for a removable handle 1812 having insert slides 1831, 1832 for moving the handle up and down the side of the housing as shown by arrow 1813. Alternatively, the track and handle may be positioned along the bottom of the housing 1810 (not shown). Still further, the handle may be integrated into the housing and fold towards a back compartment of the housing 1810 for storage when not in use (not shown). Other variations for positioning and attachment of a handle may also be used so as to allow the user to securely grip the communications device to minimize dropping the device and to enable optimal positioning of a display of the mobile communications device.

The mobile device or some other computing device may communicate with the website via the World Wide Web (WWW), Internet or Intranet. The communication medium may be compatible with WiFi communications, IEEE 802.11 communications, 2G, 2.5 G, 3G, 4G, XDSL, DSL, etc. Alternatively, the mobile device may communicate via the Public Switch Telephone Network (PSTN) or via a satellite communications work.

While the present invention has been described with respect to various features, aspects, and embodiments, those skilled and unskilled in the art will recognize the invention is not so limited. For example, the system is configured to operate with a variety of mobile communications devices, such as, for example, a terminal, a remote control device, a digital signal processor, a personal computer (PC), a wirelessly-equipped personal digital assistant (PDA), a wireless communications device, a laptop computer, etc. Other variations, modifications, and alternative embodiments may be made without departing from the spirit and scope of the present invention.

What is claimed is:

1. A retractable audio device housing system, comprising:
a housing having internal dimensions substantially the same as the external dimensions of a mobile communications device, the housing further comprising an internal cavity for mounting a retracting mechanism, wherein the cavity includes at least one wall extending along an interior surface of the housing that abuts another wall of an internal chamber, the housing further comprising a substantially flat external surface that mimics the configuration of the mobile communications device; and
the retracting mechanism that mounts within the internal chamber such that a first end of a cord is positioned to one side of the wall extending along an interior surface and a second end of a cord is positioned to the opposite side of the wall extending along an interior surface, wherein the first end of the cord comprises a connector plug adapted to be electrically connected to an output port of the mobile communications device and the second end of the cord includes at least one earpiece, wherein when the second end of cord is extracted from the cavity, the retracting mechanism becomes tensioned.

2. The system of claim 1, wherein the retracting mechanism comprises a drive wheel, a spring coupled to the drive wheel, and a idler wheel, wherein when the cord is extracted from the cavity, the spring becomes tensioned.

3. The system of claim 2, wherein the retracting mechanism further comprises a stop mechanism displaced in the housing and operatively connected to the retracting mechanism for holding the cord at selected positions when the cord is extracted from the housing.

4. The system of claim 1, wherein the second end of the cord further comprises a speaker.

5. The system of claim 1, where the earpiece includes a speaker and a microphone.

6. The system of claim 1, where in the interior side surfaces of the housing is configured with ribs to mate with at least one external side of a mobile communications device.

7. The system of claim 1, wherein the mobile communications device comprises at least one of:
an iphone,
a laptop,
a tablet,
a remote control device,
a mobile phone,
a WAP phone,
a satellite phone,
a Voice over Internet Protocol phone,
a computer,
a modem,
a pager,
a personal digital assistant,
an interactive television,
a digital signal processor,
a set top box,
an appliance, and
a Global Positioning System device.

8. The system of claim 1, further comprising:
a network connection for transmitting and receiving communications signals between the device and an external communications network.

9. The system of claim 1, wherein the external communications network comprises o communication services provider, the communications service provider monitoring a selection for presentation to the mobile communications device.

10. The system of claim 1, wherein the housing further comprises apertures adapted to correspond to locations of input and output ports or user components of the mobile communications device and to correspond to one location of at least one display of the mobile communications device.

11. The system of claim 10, wherein at least one aperture is configured for positioning earpieces on the second end of the substantially retracted cord, about or along an exterior edge surface to the mobile communications device.

12. The system of claim 1, wherein the housing further comprises an external gripping mechanism, the external gripping mechanism comprising a male tracking component positioned on an exterior edge of the housing, the male track component mating with a sliding female handle component.

13. The system of claim 1, wherein the housing further comprises an external clipping mechanism.

14. The system of claim 1, wherein the housing is further configured to mount onto a wearable strap to be worn by a user.

15. The system of claim 1, wherein the housing further comprises ventilation apertures to allow airflow about the cavity.

16. The systems of claim 1, wherein the retracting mechanism comprises means for extending and retracting the second end of the cord having the earpieces while keeping the first end of the cord stationary.

17. A retractable audio device housing system, comprising:
a housing having internal side wall dimensions substantially the same as the external side wall dimensions of a mobile communications device, the housing further comprising an internal cavity for mounting a retracting mechanism, wherein the cavity includes at least one wall extending along an interior surface of the housing that abuts another wall of an internal chamber; and
the retracting mechanism that mounts within the internal chamber such that a first end of a cord is positioned to one side of the wall extending along an interior surface and a second end of a cord is positioned to the opposite side of the wall extending along an interior surface, wherein the first end of the cord comprises a connector plug adapted to be electrically connected to an output port of the mobile communications device and the second end of the cord includes at least one foldable earpiece, wherein when the second end of cord is extracted from the cavity, the retracting mechanism becomes tensioned, and wherein the retracting mechanism further comprises a drive wheel, a spring coupled to the drive wheel, and a idler wheel, wherein when the cord is extracted from the cavity, the spring becomes tensioned.

18. The system of claim 17, wherein the internal cavity comprises a chamber for storing the retracted, folded earpieces, such that an exterior flat surface of the foldable earpieces substantially aligns with an exterior edge of the housing.

19. The system of claim 17, wherein the connector plug comprises an exterior surface that substantially aligns with an exterior edge of the housing when the plug is inserted into a port of the mobile communications device.

20. The system of claim 17, wherein the housing further comprises an external gripping mechanism, the external gripping mechanism comprising a male tracking component positioned on an exterior edge of the housing, the male track component mating with a sliding female handle component.
